(19) United States
(12) Patent Application Publication
(10) Pub. No.: US 2025/0320345 A1
(43) Pub. Date: Oct. 16, 2025

(54) RECYCLING POLYOLS PRODUCED FROM MOLDED POLYURETHANE FOAM

(71) Applicant: FAURECIA Sièges d'Automobile, NANTERRE (FR)

(72) Inventors: Anne-Sophie CABOUILLET, BOISSY-LE-SEC (FR); Marc LAUTH, STRASBOURG (FR); Florence FLAIG, ALTKIRCH (FR)

(21) Appl. No.: 18/866,247

(22) PCT Filed: May 17, 2023
(86) PCT No.: PCT/FR2023/050709

§ 371 Date: Nov. 15, 2024

(30) Foreign Application Priority Data
May 23, 2022 (FR) FR2204934

(51) Int. Cl. C08J 11/24; C08J 11/28

(52) U.S. Cl. CPC C08J 11/24; C08J 11/28; C08J 2375/04

(57) ABSTRACT

The present application relates to a method for producing a molded recycled polyurethane foam for a seat, from a molded used polyurethane foam.

### TECHNICAL FIELD

The present disclosure relates to molded polyurethane foams for motor vehicle seats. In particular, the present disclosure relates to the recycling of these polyol foams to form new molded polyurethane foams.

### PRIOR ART

The synthesis of polyurethane materials (rigid and flexible foams, elastomers, adhesives, etc.) is based on the polyaddition reaction between a polyol, such as a polyphenol, and a polyisocyanate compound. A polyol must have specific properties to be used in the manufacture of polyurethane materials. For example, a polyol intended for the manufacture of a high-resilience molded polyurethane foam for motor vehicle seats preferably has a viscosity at 25° C. of between 800 mPa·s and 1200 mPa·s, a hydroxyl number of between 26 mg(KOH)·g⁻¹ and 32 mg(KOH)·g⁻¹ and an acid number of less than 0.1 mg(KOH)·g⁻¹. Indeed, a polyol with such a high viscosity is liquid and mixes easily with the polyisocyanate compound and any additives during conventional polyurethane foam production at room temperature or in a mold heated to between 50 and 75° C. In addition, the above hydroxyl value range enables a cross-linked three-dimensional network to be obtained, giving the foam, among other things, mechanical properties suitable for use in a motor vehicle seat.

Polyols and polyisocyanate compounds are petrochemical polymers whose production generates large quantities of CO₂. To reduce dependence on oil, and also cut CO₂ emissions, it is necessary to use polyols and polyisocyanate compounds of non-petrochemical or recycled origin.

Today, molded polyurethane seat foam that has been used is mainly incinerated or landfilled, so it is not recycled. They therefore represent an alternative source to petroleum for the production of polyols, which can then be used to produce new molded polyurethane seat foams, creating a virtuous circle for the recycling of these foams.

Producing a polyol from these used foams that has the desired properties for the production of motor vehicle seat foams is no easy task. Indeed, to produce a recycled molded polyurethane foam with comfort properties that meets the requirements of motor vehicle seats, it is necessary for the depolymerization of the polyurethane in these used foams to enable very precise cutting of the polyurethane's cross-linked structure to produce small molecules comprising hydroxyl groups capable of subsequently reacting with isocyanates. It is to the inventors' credit that they have found a method that meets this need.

### SUMMARY

A method is proposed for the production of a recycled molded polyurethane foam, in particular for seats, mattresses or sofas, more particularly for seats in vehicles such as automobiles or aircraft, for furniture seats, still more particularly for car seats, said method comprising the following steps:
a) performing acidolysis treatment on molded polyurethane foam to obtain a viscous liquid,
b) mixing the viscous liquid with a first polyol and a neutralizing agent to obtain a mixture of recycled polyols, and
c) bringing the mixture of recycled polyols, an additive and a polyisocyanate compound into contact to produce the recycled molded polyurethane foam, said method being characterized in that
the molded polyurethane foam is a high-resilience molded polyurethane foam, in particular for seats, mattresses or sofas, more particularly for seats in vehicles such as automobiles or aircraft, for furniture seats, still more particularly for car seats, and
the viscous liquid:first polyol mass ratio in the mixture of recycled polyols is between 90:10 and 10:90, in particular between 80:20 and 20:80, most particularly between 50:50 and 75:25.

During step a) of acidolysis treatment, which is a conventional step known to the person skilled in the art, the polyurethane in the molded polyurethane foam will depolymerize to form the viscous liquid comprising amino compounds and polyols. The polyols in the viscous liquid react with the polyisocyanate compound in step c) of the method of the present invention to produce recycled molded polyurethane foam, in particular for seats, which can comprise up to 30% by weight of molded polyurethane foam.

However, the inventors have found that the viscous liquid cannot be used as such in step c) due to its high viscosity and high acid number. In fact, its high viscosity interferes with pumping and injection into the mold used to produce the molded polyurethane foam. In addition, the molded polyurethane foam produced is destabilized by the high viscosity and high acid number of the viscous liquid.

Without being bound by any theory, the inventors are of the opinion that the high viscosity of the viscous liquid is due to the incomplete and/or non-selective depolymerization of the urethane and urea hard segments of the polyurethane foam molded in step a), which produces small-diameter oligomer particles (much smaller than 100 μm) in a liquid medium. The high acid number of the viscous liquid results from the use of acid in step a) to acidolyze the molded polyurethane foam.

It is to the inventors' credit that they have found that step b) of the method of the invention solves this problem.

In fact, the inventors believe that the mixture of recycled polyols has a viscosity and acid number suitable for step c) thanks to the first polyol and the neutralizing agent, respectively. In particular, the viscosity and acid number of the mixture of recycled polyols means that step c) can be carried out in a normal industrial context, without modifying conventional equipment.

Thus, thanks to steps a), b) and c), the method of the present invention creates a virtuous circle of recycling a significant quantity of used molded polyurethane seat foam into recycled molded polyurethane foam, in particular seat foam, whereas this element is not normally recycled.

Thanks to this virtuous circle, the method of the present invention makes it possible to reduce the environmental impact, to reduce the pollution generated by the incineration of used molded polyurethane seat foam, and to reduce the CO₂ emissions of the foam production chain.

The method of the present invention also makes it possible to reduce and limit the volatility of the production costs of molded polyurethane foam, in particular for seats, by limiting the amount of polyols of petroleum origin incorporated into this foam.

In addition, the foam produced by the method of the present invention has mechanical properties, in particular density, tear propagation strength, and compression set, that are on the same order of magnitude as a molded industrial foam produced from petrochemical polyols and commonly used in car seats. The molded foam produced by the method of the present invention also has a reactivity, characterized by a foam rise profile that is comparable to the rise profile of an industrial foam produced from petrochemical polyols and commonly used in seats. The foam produced by the method of the present invention can therefore be used in seats, mattresses or sofas, in particular for vehicle seats such as an automobile or an aircraft, for seats for furnishing, more particularly for car seats. What's more, this foam does not require any changes to the conventional industrial method for producing molded polyurethane foam, especially for seats. The foam produced by the method of the present invention can also be applied in an armrest, in seat components such as a headrest, in a vehicle dashboard, or in a vehicle door panel.

According to another aspect, a molded polyurethane foam is proposed, in particular for seats, mattresses or sofas, more particularly for seats in vehicles such as cars or aircraft, for furniture seats, still more particularly for car seats, obtainable by the method of the present invention.

### BRIEF DESCRIPTION OF THE DRAWINGS

Other features, details and advantages will appear on reading the detailed description below, and on analyzing the appended drawings, in which:

FIG. 1 shows the rise profile of foams according to the invention (Polyol 50% and Polyol 75%) and a comparative foam.

FIG. 2 shows different photos of foams according to the invention and a reference foam.

FIG. 3 shows a graph comparing the density of a foam according to the invention and a reference foam.

FIG. 4 shows a graph comparing the tear propagation strength of a foam according to the invention and a reference foam.

FIG. 5 shows a graph comparing the compression set of a foam according to the invention and a reference foam at constant thickness.

### DESCRIPTION OF THE EMBODIMENTS

A method is proposed for the production of a recycled molded polyurethane foam, in particular for seats, mattresses or sofas, more particularly for seats in vehicles such as automobiles or aircraft, for furniture seats, still more particularly for car seats, said method comprising the following steps:
a) performing acidolysis treatment on molded polyurethane foam to obtain a viscous liquid,
b) mixing the viscous liquid with a first polyol and a neutralizing agent to obtain a mixture of recycled polyols, and
c) bringing the mixture of recycled polyols, an additive and a polyisocyanate compound into contact to produce the recycled molded polyurethane foam, said method being characterized in that
the molded polyurethane foam is a high-resilience molded polyurethane foam, in particular for seats, mattresses or sofas, more particularly for seats in vehicles such as automobiles or aircraft, for furniture seats, still more particularly for car seats, and
the viscous liquid:first polyol mass ratio in the mixture of recycled polyols is between 90:10 and 10:90, in particular between 80:20 and 20:80, most particularly between 50:50 and 75:25.

For the purposes of the present invention, the term “foam” as used, for example, in the expression “polyurethane foam”, designates a compound with a three-dimensional cellular structure of the expanded type.

For the purposes of this invention, the term “molded seat foam” refers to all or part of a foam having mechanical properties suitable for a seat component and produced in a mold having a shape suitable for a seat component, all or part of a waste product from this production, and mixtures thereof.

Typically, the molded seat foam can be foam from an end-of-life vehicle as defined in European Directive 2000/53/EC of Sep. 18, 2000.

For the purposes of this invention, the term “high resilience” is used to describe foam with a resilience of over 70% (at the 5^{th} compression cycle according to test method D45 5128 (PSA)).

The step a) of acidolysis treatment is a conventional step known to the person skilled in the art. It is described, for example, in POLIMERY 2018, 63, nr 3 234-238. The person skilled in the art will know how to use it to obtain a viscous liquid, in particular a viscous liquid with the following properties:
a hydroxyl value of between 20 mg(KOH)·g⁻¹ and 100 mg(KOH)·g⁻¹, more particularly between 25 mg(KOH)·g⁻¹ and 60 mg(KOH)·g⁻¹,
an acid number greater than 1 mg(KOH)·g⁻¹, in particular between 5 mg(KOH)·g⁻¹ and 20 mg(KOH)·g⁻¹, and
a viscosity at 25° C. greater than 15,000 mPa·s, in particular between 20,000 mPa·s and 50,000 mPa·s.

For the purposes of this invention, “hydroxyl number” (also known as “OH number”) represents the amount of potassium hydroxide in mg corresponding to the number of hydroxyl groups present in 1 g of material.

Advantageously, the range of hydroxyl values of the viscous liquid enables a cross-linked three-dimensional network to be obtained, giving the foam, among other things, mechanical properties suitable for use in an automotive seat.

Furthermore, the high viscosity of the viscous liquid interferes with pumping and injecting it into the mold used to produce the molded polyurethane foam. In addition, the molded polyurethane foam produced is destabilized by the high viscosity and high acid number of the viscous liquid.

For the purposes of this invention, “acid number” refers to the amount of residual acidic material in the polyol. It is reported in terms of the number of milligrams of potassium hydroxide required to neutralize the acid present in one gram of sample.

For the purposes of this invention, “viscosity at 25° C.” means Brookfield viscosity and/or viscosity measured by a cone-plane viscometer at 25° C.

The first polyol is a petrochemical, recycled or biosourced polyol enabling the production of polyols of varying functionality. The first polyol may, for example, be selected from alkoxylated glycerol, alkoxylated sorbitol, alkoxylated diethyltriamine, alkoxylated sucrose, polyoxypropylene glycol-based polyols and mixtures thereof, in particular polyoxypropylene glycol-based polyols and mixtures thereof.

Caradol SA34-05, Wanol F3135, Lupranol 2095 and Lupranol 2090 are examples of commercial polyols suitable for use as the first polyol in the method of the present invention.

The neutralizing agent can be a basic inorganic salt, an amino compound or an alcohol or mixtures thereof, in particular a basic inorganic salt, an amino compound, or mixtures thereof.

Typical basic inorganic salts include sodium hydroxide, potassium hydroxide, calcium chloride, calcium carbonate, sodium bicarbonate, and mixtures thereof.

Typically, the amino compound can be ammonia, dimethylaminopropylamine (DMAPA) and mixtures thereof.

The person skilled in the art will know how to adjust the neutralizing agent content to obtain the mixture of recycled polyols.

According to one embodiment, the mixing step b) can be carried out in 1 or more stages, in particular 1, 2, 3 or 4 stages, more particularly 1 or 2 stages.

Advantageously, carrying out step b) in several stages enables the properties of the mixture of recycled polyols to be adjusted as required according to demand, for example the content of molded polyurethane foam in the recycled molded polyurethane foam.

This also enables step b) to be carried out at the site where the viscous liquid is produced, to reduce its viscosity and make it easier to transport to the site where the recycled molded polyurethane foam is produced. At this second production site, step b) can be carried out again to obtain the mixture of recycled polyols. This reduces the cost of transporting the first polyol.

The mixture of recycled polyols may have an acid number less than or equal to 1 mg(KOH)·g⁻¹, in particular less than or equal to 0.5 mg(KOH)·g⁻¹ and at least one, in particular both, of the following features:
a viscosity at 25° C. of between 500 mPa·s and 15,000 mPa·s, and
a hydroxyl value of between 20 mg(KOH)·g⁻¹ and 100 mg(KOH)·g⁻¹, in particular between 25 mg(KOH)·g⁻¹ and 60 mg(KOH)·g⁻¹,

These features depend on the properties of the viscous liquid, in particular its viscosity and acid number, the nature of the first polyol and the viscous liquid:first polyol mass ratio described above. The person skilled in the art will know how to adjust these parameters to obtain the mixture of recycled polyols that can comprise at least one, in particular two, most particularly all of these features.

The inventors have noted that molded polyurethane foam produced from such a mixture of recycled polyols incorporated into a formulation comprising an additive and a polyisocyanate compound has mechanical properties suitable for use in a seat.

In particular, the range of hydroxyl values indicated above enables a cross-linked three-dimensional network to be obtained, giving the foam, among other things, mechanical properties suitable for use in an automotive seat. What's more, the molded polyurethane foam produced from such a mixture of recycled polyols is not destabilized by the viscosity and acid number of the mixture of recycled polyols.

Furthermore, the viscosity at 25° C. of the mixture of recycled polyols enables said mixture of recycled polyols to be advantageously liquid at 25° C. and to be easily incorporated into a formulation comprising the additive and the polyisocyanate compound in step c) to produce the recycled molded polyurethane seat foam.

According to one embodiment, the method of the present invention may further comprise, between step b) and step c):
a step of mixing the mixture of recycled polyols with a second polyol to obtain a mixture of formulated polyols which is then used in step c),
the mixture of recycled polyols:second polyol mass ratio in the mixture of recycled polyols is between 1:99 and 99:1, in particular between 20:80 and 80:20, most particularly between 50:50 and 75:25.

This mixing step can also be carried out at the same time as step b). In this case, the viscous liquid is mixed simultaneously with the first polyol and the second polyol.

Advantageously, this method provides the necessary conditions for casting recycled molded polyurethane foams using standard equipment such as feed pumps, injection pumps, and mixing heads.

Typically, the second polyol can be chosen from polyoxypropylene-polyoxyethylene glycol-based polyols initiated with glycerol (triols).

Nextyol Y-3322N and Rokopol 6010 are examples of commercial polyols suitable for use as a second polyol in the method of the present invention.

The mixture of formulated polyols may have an acid number less than 1 mg(KOH)·g⁻¹, in particular less than or equal to 0.5 mg(KOH)·g⁻¹ and at least one, in particular both, of the following features:
a viscosity at 25° C. of between 500 mPa·s and 10000 mPa·s, and
a hydroxyl value of between 20 mg(KOH)·g⁻¹ and 100 mg(KOH)·g⁻¹, in particular between 25 mg(KOH)·g⁻¹ and 60 mg(KOH)·g⁻¹.

These features depend on the properties of the mixture of recycled polyols, the nature of the second polyol and the first polyol:second polyol mass ratio described above. The person skilled in the art will know how to adjust these parameters to obtain the mixture of formulated polyols that can comprise at least one, in particular two, most particularly all of these features.

Typically, the polyisocyanate compound may be selected from m-phenylene diisocyanate, toluene 2,4-diisocyanate, toluene 2,6-diisocyanate, hexamethylene 1,6-diisocyanate, 1,4-tetramethylene diisocyanate, cyclohexane 1,4-diisocyanate, hexahydrotoluene diisocyanate, naphthylene 1,5-diisocyanate, methoxyphenyl-2,4-diisocyanate, 4,4′-diphenylmethane diisocyanate and its isomers, 4,4′-biphenylene diisocyanate, 3,3′-dimethoxy-4,4′-biphenyl diisocyanate, 3,3′-dimethyl-4,4′-biphenyl diisocyanate, 3,3′-dimethyldiphenylmethane 4,4′-diisocyanate, 4,4′,4″-triphenyl methane triisocyanate, polymethylene polyphenylisocyanate, polymeric diphenylmethane diisocyanate, isophorone diisocyanate, 2,4,6-triisocyanate toluene, 4,4′-dimethyldiphenylmethane-2,2′,5,5′-tetraisocyanate, polymethylene polyphenyl isocyanate ester and mixtures thereof, in particular toluene 2,4-diisocyanate, toluene 2,6-diisocyanate, hexamethylene 1,6-diisocyanate, 4,4′-diphenylmethane diisocyanate, polymethylene polyphenylisocyanate, polymeric diphenylmethane diisocyanate, isophorone diisocyanate, isocyanic acid polymethylene polyphenyl ester and mixtures thereof, especially 4,4′-diphenylmethane diisocyanate and its isomers, polymethylene polyphenylisocyanate, polymeric diphenylmethane diisocyanate, toluene 2,4-diisocyanate, toluene 2,6-diisocyanate, polymethylenepolyphenyl isocyanic acid ester and mixtures thereof, especially polymeric diphenylmethane diisocyanate.

The mass ratio of mixture of recycled polyols:polyisocyanate compound can be between 1:99 and 95:5, in particular between 20:80 and 80:20, most particularly between 55:50 and 75:25. The person skilled in the art will know how to adjust this ratio according to the properties desired for the high-resilience molded polyurethane foam.

An additive is also used during the contact step c). It can be used to modify and/or improve the properties of the high-resilience molded polyurethane foam produced.

Typically, the additive can be selected from a surfactant, a crosslinking agent, a flame retardant, a blowing agent, a release agent, an anti-hydrolysis agent, a biocide and mixtures thereof, in particular selected from a surfactant, a crosslinking agent, a flame retardant, a blowing agent and mixtures thereof, more particularly being a mixture of surfactant, blowing agent and crosslinking agent.

For the purposes of the present invention, “flame retardant” means a compound having the property of reducing or preventing the combustion or heating of the materials it impregnates or coats. The flame retardant may, for example, be antimony, graphite, silicate, boron, a compound containing a halogen, nitrogen, or phosphorus such as tris(1-chloro-2-propyl)phosphate (TCPP), triethylene phosphate (TEP), triaryl phosphate ester, ammonium polyphosphate, red phosphorus, trishalogenaryl or mixtures thereof.

For the purposes of this invention, “crosslinking agent” refers to a compound that generates the formation of one or more three-dimensional networks in molded high-resilience polyurethane foam. The crosslinking agent can be selected from glycerol, diethanolamine, triethanolamine, glycols with a molecular weight of less than 1000 and a functionality of greater than or equal to 3, and mixtures thereof, in particular diethanolamine.

For the purposes of the present invention, “blowing agent” refers to a compound that induces expansion of a composition by chemical and/or physical action during a foaming stage. Typically, the chemical blowing agent is selected from water, formic acid, phthalic anhydride, and acetic acid. The physical blowing agent can be selected from pentane and pentane isomers, hydrocarbons, hydrofluorocarbons, hydrochlorofluoroolefins, hydrofluoroolefins (HFOs), ethers and mixtures thereof. An example of a blowing agent of the ether type is methylal. According to the invention, a mixture of chemical and physical blowing agents is, for example, a mixture of water/pentane isomer or formic acid/pentane isomer or water/hydrofluoro-olefins or pentane isomer/methylal/water or water/methylal.

In a particular embodiment, the blowing agent is water.

For the purposes of the present invention, “surfactant” refers to an agent enabling the physical stability of the polymer matrix during the advancement of reactions, in particular through anti-coalescent stabilization during polymerization. Typically, the surfactant is selected from any of the following: silicone glycol copolymers, non-hydrolyzable silicone glycol copolymers, polyalkylene siloxane copolymers, polyoxyalkylene methylsiloxane copolymers, a polyetherpolysiloxane copolymer, a polydimethylsiloxane polyether copolymer, a polyethersiloxane, a modified polyether-polysiloxane copolymer, a polyoxyalkylene block polysiloxane copolymer and derivatives or mixtures thereof

The release agent can be talc, a paraffin solution, silicone or mixtures thereof, or a suspension or emulsion of paraffin waxes or oils dispersed in water, a water-solvent (hybrid) mixture or in a solvent or mixture of solvents.

The polyurethane foam produced by the method of the invention is molded.

Step c) can therefore be carried out in a mold having a shape suitable for a seat component, in particular a car seat, an aircraft seat, a furniture seat, most particularly a car seat.

Alternatively, step c) can be carried out in a mold that does not represent a suitable shape for a seat component to produce a molded polyurethane foam, then this foam is formed into a shape suitable for a seat component.

The mixture of recycled polyols, additive and polyisocyanate compound can be pre-mixed and the resulting mixture introduced into the mold.

The mold wherein step c) is carried out can be heated. Thus, the reaction step c) can be carried out at a temperature of between 30° C. and 100° C., in particular between 40° C. and 80° C., most particularly between 50° C. and 65° C.

A catalyst can be used to accelerate the kinetics of the reaction between the polyol mixture and the polyisocyanate compound and between the polyisocyanate compound and the chemical blowing agent during the contact step of the polyurethane foam manufacturing method.

Thus, according to one embodiment, step c) of the method of the present invention can be carried out in the presence of a catalyst.

The amount of catalyst used in the polyurethane foam production method of the invention depends on the compounds used in the method. The person skilled in the art will know how to adapt this quantity.

Typically, the catalyst can be selected from catalysts known to catalyze expansion (water-isocyanate) and gelation (polyol-isocyanate) reactions. N,N,N′-trimethyl-N′-hydroxyethyl-bisaminoethylether, bis(2-dimethyl-aminoethyl) ether, 1,3-bis[3-(dimethylamino)propyl]urea, 2-[2-(Dimethylamino)ethoxy]ethyl [3-[[[[2-[2-(dimethylamino)ethoxy]ethoxy]carbonyl]amino]methyl]-3,5,5-trimethylcyclohexyl]carbamate, n-[2-[2-(dimethylamino)ethoxy]ethyl]-N-methyl-1,3-propanediamine (DABCO NE300), 1,4-diazabicyclooctane (TEGOAMIN 33), N′-[3-(dimethylamino)propyl]-N,N-dimethylpropane-1,3-diamine (POLYCAT 15) or mixtures thereof are catalysts that can be used in the method of the present invention.

According to one embodiment, the method may further comprise, prior to step a) of acidolysis treatment, a step of grinding the molded polyurethane foam to obtain particles with a diameter of between 1 mm and 20 mm, in particular between 3 mm and 10 mm, most particularly between 4 mm and 6 mm, which are then used in step a) of acidolysis treatment.

The particle size can be determined by sieving.

The use of particles with diameters in these ranges facilitates and accelerates depolymerization of the molded polyurethane foam.

Typically, this grinding step can be carried out by cryogenics followed by vibration ball mill grinding, knife mill grinding, hammer mill grinding, shredder grinding, centrifugal grinding, or pulse energy grinding, or combinations thereof. These methods are known to the person skilled in the art. That person will know how to select and implement the method best suited to the polyurethane molded foam to be ground up.

The viscous liquid obtained after step a) may comprise solid impurities such as pieces of foam that have not reacted with the acid. These solid impurities can affect step c) and thus alter the production method of the molded polyurethane foam produced.

To alleviate these problems, the method of the present invention may further comprise, between step a) and step b):
a step of filtering the viscous liquid to obtain a viscous liquid free of solid particles.

The filtration step is a conventional step known to the person skilled in the art. That person knows how to put it into practice.

Amino compounds in the viscous liquid can impair the implementation of step c) of the method of the present invention.

To alleviate this problem, the method of the present invention may further comprise, between step a) and step b):
a step of deaminating the viscous liquid to obtain a viscous liquid totally or partially devoid of amino compounds.

According to another aspect, a molded polyurethane foam is proposed for seats, in particular for car seats, for aircraft seats, for furniture seats, more particularly for car seats, obtainable by the method of the present invention.

Advantageously, this molded polyurethane seat foam has properties, in particular density, tear propagation strength, and compression set at constant thickness, of the same order of magnitude as an industrial polyurethane foam produced from petrochemical polyols and commonly used in car seats. This polyurethane foam can therefore be used in car seats.

### EXAMPLES

The following examples shows the invention without limiting it.

In these examples, measurements are taken to the following standards:
hydroxyl number per ISO 14900:2017,
acid number per ASTM D7253-22 (2022),
density per DIN EN ISO 845 (2006),
tear propagation strength per PV3410 (2017), and
compression set per DIN EN ISO 1856 (2018),

In these examples, the foam rise profile is determined according to the following protocol. The polyol, the polyisocyanate compound, and the additives are mixed and poured into a container for a given time (5 s). At the end of this period, a device (Universal Foam Qualification System, FORMAT Messtechnik) measures the expansion height over time.

### Example 1a: Obtaining the Mixture of Recycled Polyols

Molded polyurethane foam particles with a particle size of less than 6 mm are contacted with adipic acid to obtain a viscous liquid by acidolysis treatment.

The viscous liquid has the following features:
hydroxyl index of 30 mg(KOH)·g⁻¹,
acid number of 8 mg(KOH)·g⁻¹, and
viscosity at 25° C. of 35,000 mPa·s.

As such, it cannot be used in a reaction to produce molded polyurethane foam. In fact, its high viscosity interferes with pumping and injection into the mold used to produce the molded polyurethane foam. In addition, the molded polyurethane foam produced would be destabilized by its high viscosity and acid number.

This viscous liquid is then mixed with a first polyol, Lupranol 2095 polyol (BASF), and a neutralizing agent (KOH) to obtain a mixture of recycled polyols. The viscous liquid:first polyol mass ratio of the mixture of recycled polyols is 65:35.

The mixture of recycled polyols has the following features:
hydroxyl index of 28 mg(KOH)·g⁻¹,
acid number of 0.5 mg(KOH)·g⁻¹, and
viscosity of 6500 mPa·s at 25° C.

It can be used, as such, in a molded polyurethane foam production reaction because it has a viscosity, hydroxyl number, and acid number all suitable for the process of molding high-resilience padding on standard production machines.

### Example 1b: Obtaining the Mixtures of Recycled Polyols

The mixture of recycled polyols from Example 1b is mixed, in different proportions, with a second polyol, which is Rokopol 6010, to obtain different formulated polyols.

The mixture of recycled polyols:second polyol mass ratio of the formulated polyol blend, hereinafter referred to as polyol 50%, is 50:50.

The mixture of recycled polyols:second polyol mass ratio of the formulated polyol blend, hereinafter referred to as polyol 75%, is 75:25.

The 50% polyol has the following features:
hydroxyl index of 28 mg(KOH)·g⁻¹,
acid number of 0.25 mg(KOH)·g⁻¹, and
viscosity of 3000 mPa·s at 25° C.

The 75% polyol has the following features:
hydroxyl index of 28 mg(KOH)·g⁻¹,
acid number of 0.4 mg(KOH)·g⁻¹, and
viscosity of 5000 mPa·s at 25° C.

They can be used, as such, in a molded polyurethane foam production reaction because it has a viscosity, hydroxyl number, and acid number all suitable for the process of molding high-resilience padding on standard production machines.

### Example 2: Production of High-Resilience Molded Polyurethane Foams from the Formulated Polyols of Example 1b

### Example 2a: Polyol 50%

A rise profile is determined for a foam obtained by mixing 57% by weight of polyol 50%, 38% by weight of an isocyanate compound (ISO 135/161 (BASF)), 1.9% by weight of water (blowing agent), 1% by weight of TEGOSTAB® B 8715 LF2 (surfactant), 1% by weight of diethanolamine (crosslinking agent), 0.1% by weight of DABCO NE 300 (catalyst) and 1% by weight of POLYCAT 15 (catalyst).

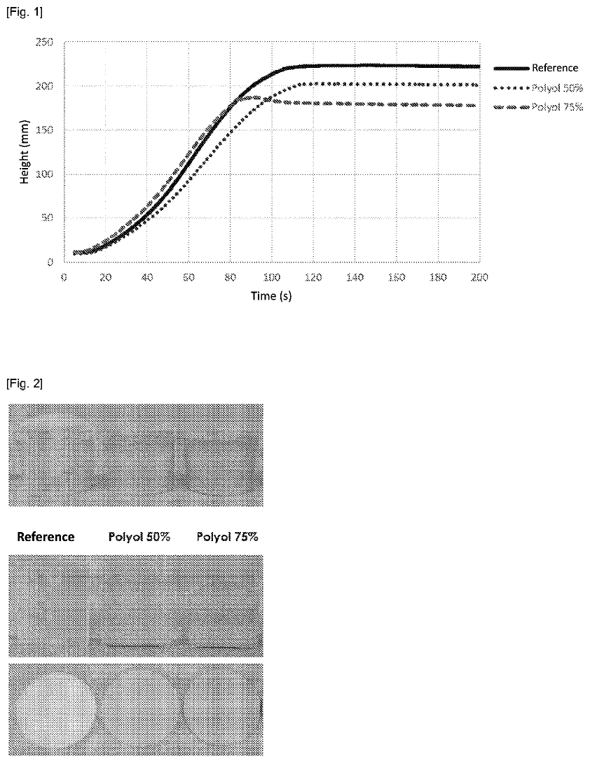

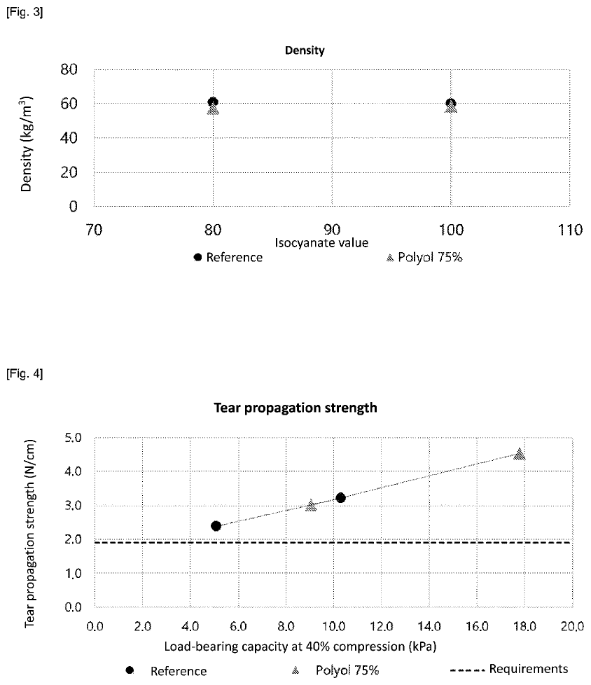

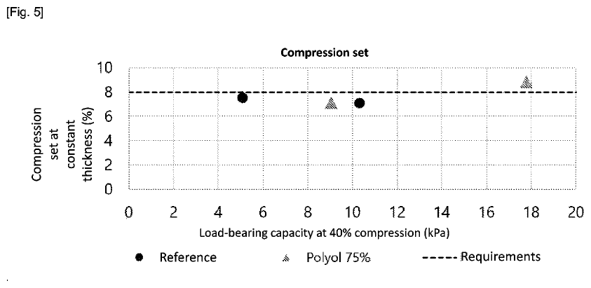

As shown in [FIG. 1] and [FIG. 2], this foam has a foam rise profile and structure comparable to a reference foam suitable for use in a seat and obtained from Rokopol 6010, that is to say a petrochemical polyol.

It can therefore be used in a seat.

### Example 2a: Polyol 75%.

The foam rise profile is determined for a foam obtained by mixing 57% by weight of polyol 75%, 38% by weight of an isocyanate compound (ISO 135/161 (BASF)), 1.9% by weight of water (blowing agent), 1% by weight of TEGOSTAB® B 8715 LF2 (surfactant), 1% by weight of diethanolamine (crosslinking agent), 0.2% by weight of DABCO NE 300 (catalyst) and 0.9% by weight of POLYCAT 15 (catalyst).

As shown in [FIG. 1] and [FIG. 2], the foam obtained from polyol 75% has a foam rise profile and structure comparable to a reference foam suitable for use in a seat and obtained from Rokopol 6010, that is to say a petrochemical polyol.

It can therefore be used in a seat.

This is confirmed by [FIG. 3] to [FIG. 5]. These figures show that the foam obtained from polyol 75% has properties of the same order of magnitude as those of the reference foam.

1. A method for producing recycled molded polyurethane foam comprising the following steps:
a) performing acidolysis treatment on molded polyurethane foam to obtain a viscous liquid,
b) mixing the viscous liquid with a first polyol and a neutralizing agent to obtain a mixture of recycled polyols, and
c) bringing the mixture of recycled polyols, an additive and a polyisocyanate compound into contact to produce the recycled molded polyurethane foam,
wherein
the molded polyurethane foam is a high-resilience molded polyurethane foam, and the viscous liquid:first polyol mass ratio in the mixture of recycled polyols is between 90:10 and 10:90.

2. The method according to claim 1 wherein the recycled molded polyurethane foam is for a seat.

3. The method according to claim 1 wherein the recycled molded polyurethane foam is for the group consisting of a mattress, a sofa, an armrest, a seat component such as a headrest, a vehicle dashboard, or a vehicle door panel.

4. The method according to claim 1, wherein the viscous liquid has the following properties:
a hydroxyl value of between 20 mg(KOH)·g⁻¹ and 100 mg(KOH)·g⁻¹,
an acid number greater than 1 mg(KOH)·g⁻¹, and
a viscosity at 25° C. greater than 15,000 mPa·s.

5. The method according to claim 1 wherein the first polyol is selected from the group consisting of alkoxylated glycerol, alkoxylated sorbitol, alkoxylated diethyl triamine, alkoxylated sucrose, polyoxypropylene glycol-based polyols and mixtures thereof.

6. The method according to claim 1 wherein step b) is carried out in 1 or more stages.

7. The method according to claim 1 wherein the mixture of recycled polyols has an acid number less than or equal to 1 mg(KOH)·g⁻¹ and at least one of the following features:
a viscosity at 25° C. of between 500 mPa·s and 15,000 mPa·s, and
a hydroxyl value of between 20 mg(KOH)·g⁻¹ and 100 mg(KOH)·g⁻¹.

8. The method according to claim 1 further comprising, between step b) and step c):
a step of mixing the mixture of recycled polyols with a second polyol to obtain a mixture of formulated polyols which is then used in step c),
the mixture of recycled polyols:second polyol mass ratio in the mixture of formulated polyols being between 1:99 and 99:1.

9. The method according to claim 8 wherein the second polyol is selected from the group consisting of polyoxypropylene-polyoxyethylene glycols initiated with glycerol.

10. The method according to claim 1 wherein the polyisocyanate compound is selected from the group consisting of m-phenylene diisocyanate, toluene 2,4-diisocyanate, toluene 2,6-diisocyanate, hexamethylene 1,6-diisocyanate, tetramethylene 1,4-diisocyanate, cyclohexane 1,4-diisocyanate, hexahydrotoluene diisocyanate, naphthylene 1,5-diisocyanate, methoxyphenyl-2,4-diisocyanate, diphenylmethane 4,4′-diisocyanate and isomers thereof, 4,4′-biphenylene diisocyanate, 3,3′-dimethoxy-4,4′-biphenyl diisocyanate, 3,3′-dimethyl-4,4′-biphenyl diisocyanate, 3,3′-dimethyldiphenylmethane 4,4′-diisocyanate, 4,4′,4″-triphenyl methane triisocyanate, polymethylene polyphenylisocyanate, polymeric diphenylmethane diisocyanate, isophorone diisocyanate, 2,4,6-triisocyanate toluene, 4,4′-dimethyldiphenylmethane-2,2′,5,5′-tetraisocyanate, isocyanic acid polymethylenepolyphenyl ester and mixtures thereof.

11. The method according to claim 1, wherein the mass ratio of mixture of recycled polyols:polyisocyanate compound is between 1:99 and 95:5.

12. The method according to claim 1 wherein the additive is selected from the group consisting of a surfactant, a crosslinking agent, a flame retardant, a blowing agent, a release agent, an anti-hydrolysis agent, a biocide, and mixtures thereof.
